(19) United States
(12) Patent Application Publication
(10) Pub. No.: US 2002/0171353 A1
(43) Pub. Date: Nov. 21, 2002

(54) Tracking picture tube

(75) Inventor: Antonius Hendricus Maria Holtslag, Eindhoven (NL)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/145,676

(22) Filed: May 15, 2002

(30) Foreign Application Priority Data
May 17, 2001 (EP) 01201871.9

(51) Int. Cl. H01J 29/10

(52) U.S. Cl. 313/471

(57) ABSTRACT

The present invention relates to a tracking picture tube of the type in which comb-shaped electrodes or optical detecting means (22, 23) are used for generating a signal relative to the position of electron beams (9r, 9g, 9b) deflected onto phosphor strips (5r, 5g, 5b). The tube is characterized in that a first peripheral (uppermost) strip (5r) of said group of adjacent strips borders only finger portions (24a, 24b) of the first detecting means (22) in said pair of detecting means, and a second peripheral (lowermost) strip (5b) of said group of adjacent strips borders only finger portions (25a, 25b) of the second electrode (23) in said pair of detecting means.

This configuration ensures improved tracking of the beams with respect to the centrally located phosphor strip.

The present invention relates to a picture tube in which at least one pair of comb-shaped electron-detecting means with a plurality of interdigitated finger portions is used for generating an electric signal relative to the position of electron beams deflected onto parallel strips of light-emitting material. Such picture tubes are also known as tracking tubes.

The most common type of cathode ray tube comprises a shadow mask, arranged on the inside of the screen on top of the phosphor layer. The shadow mask has the function of shadowing two of the three phosphor areas when the third is being illuminated by an electron beam. Thus, when the “red” electron beam is activated, the shadow mask shadows the green and blue phosphor areas, etc.

The shadow mask has several drawbacks, for example, it is heavy, costly and absorbs roughly 80% of the electrons emitted from the gun.

There are also cathode ray tubes without shadow masks, sometimes referred to as tracking CRTs.

In such tubes, known from e.g. GB 2122415, the different phosphor areas are arranged in groups of strips, normally with a horizontal extension across the screen, and each electron beam is deflected to land on the correct strip. The deflection is controlled by a tracking system that receives its control signals from electrodes located adjacent and in between the phosphor strips. In accordance with the most commonly used arrangement, two electrodes with elongate finger portions are arranged in an interdigitated fashion, so that each phosphor strip is located between finger portions belonging to different electrodes. Each electrode is arranged to detect a signal resulting from electron beams landing on the electrode, and the signals from the two electrodes are compared (e.g. subtracted and normalized to the sum of the currents detected). The relationship between these signals is used to control the beam deflection unit in a feedback position control system.

Basically, there are two different categories of intelligent tracking CRTs, namely:

1) single-beam systems, with only one electron gun, alternately illuminating phosphor strips of different colors, and

2) multi-beam systems, where several electron guns are employed, each illuminating one of the phosphor strip groups. The multi-beam systems of course have the advantage of writing red, blue and green information in one sweep.

The latter category, to which the present invention is related, is described in U.S. Pat. No. 2,757,313 and GB 1403061. In both these publications, the method used is to track one of the beams (master beam), and to adjust the assembly of beams based on this position information. According to these documents, only one of the phosphor strips (corresponding to the master beam) needs to be surrounded by electrode finger portions, and the reference signal generated from these portions controls the deflection unit. A problem in this context is to separate the influence of the master beam (e.g. red) on the electrodes from the influence from adjacent beams (e.g. green, blue). Two ways of accomplishing this separation are mentioned in the cited documents, namely

1) modulating the master beam with a specific frequency, and filtering the reference signal, or

2) physically separating the master beam phosphor strips from the adjacent phosphor strips.

Both of these solutions lead to complicated and costly designs.

Moreover, according to the prior art, if only one beam is turned on, it is not clear on which phosphor strip the beam is focusing.

It is an object of the present invention to provide a picture tube with satisfactory three-beam tracking.

It is a further object to provide a three-beam tracking that can adjust the beam carrying red, blue or green video information on the corresponding phosphor strip.

These and other objects are achieved with a picture tube of the type mentioned in the opening paragraph, wherein a first peripheral (uppermost) strip of said adjacent strips borders only finger portions of the first detecting means in said pair of detecting means, and a second peripheral (lowermost) strip of said adjacent strips borders only finger portions of the second detecting means in said pair of detecting means.

This configuration ensures improved tracking of the beams with respect to the phosphor strip located between the peripheral strips. With this electrode structure, the signals generated by the peripheral electron beams will have opposite signs and cancel each other when the beams are centered in relation to the adjacent strips. When the beams are off-centered, i.e. a little too high or low, the signal from one of the peripheral beams will dominate, and the resulting signal can be used as a position control signal.

The inventive detecting means configuration can be used for tracking three (or more) activated beams in relation to the group of adjacent strips. This enables fast tracking of the three beams, eliminating position errors that affect all beams in the same way.

According to a first embodiment, each peripheral strip only borders one finger portion, i.e. on strip side borders a detecting means while the other does not. This requires fewer finger portions, and therefore a less expensive detecting means structure.

In this case, the finger portions are preferably located on the peripheral side of said peripheral strips, so that all strips in a group of three selected strips are located between finger portions belonging to different detecting means. The three corresponding beams will thus be enclosed between the two detecting means, and a zero signal will only be obtained when the three beams are centered between the detecting means.

According to a second embodiment, the first peripheral strip is located between finger portions belonging to said first detecting means, and the second peripheral strip is located between finger portions belonging to said second detecting means. This structure gives a wider range of resulting signals, i.e. the position error signal becomes larger with a larger beam deviation.

In this case, a third of said adjacent strips, centrally located between the peripheral strips, preferably borders finger portions belonging to different detecting means. With three beams and a group of three strips, this structure will result in groups of three finger portions extending alternately from each detecting means. In a first strip group, the uppermost strip will be surrounded by finger portions from one of the detecting means, while in the next group, the uppermost strip will be surrounded by finger portions from the other detecting means.

This allows tracking of three beams in relation to the center strip in the group of adjacent strips. As each peripheral strip borders two finger portions of the same detecting means, the control signal, which is generated when the three beams are off-centered, is stronger.

The detecting means may be preferably conductive electrodes as mentioned above, but may also comprise light-emitting material in combination with a light-sensitive means. Such optical tracking can be advantageous in some applications.

These and other aspects of the invention are apparent from the preferred embodiments described with reference to the appended drawings.

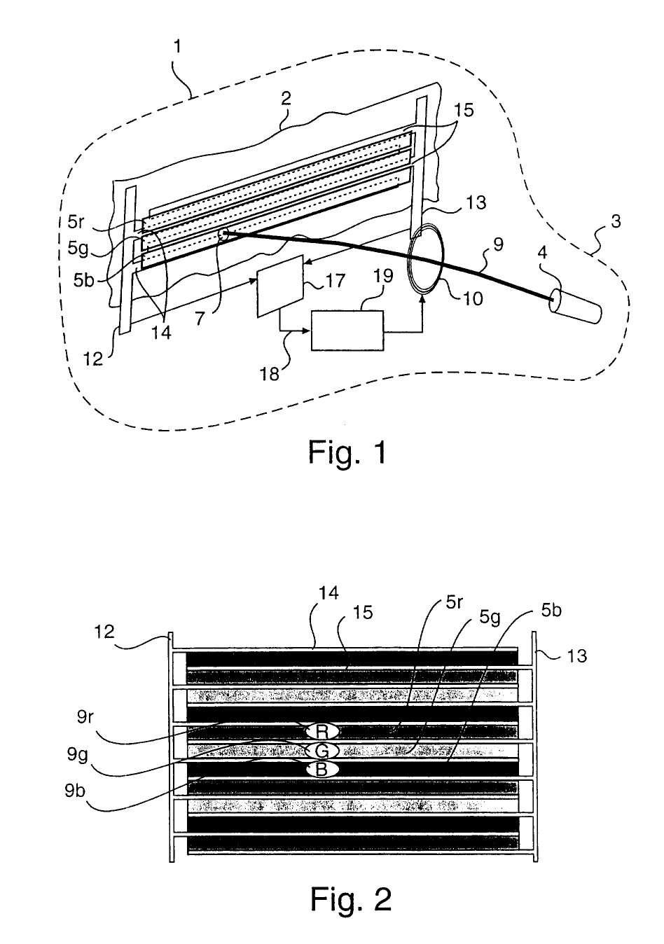

FIG. 1 schematically illustrates the principle of the tracking tube.

FIG. 2 shows the arrangement of the phosphor strips and electrodes according to the prior art.

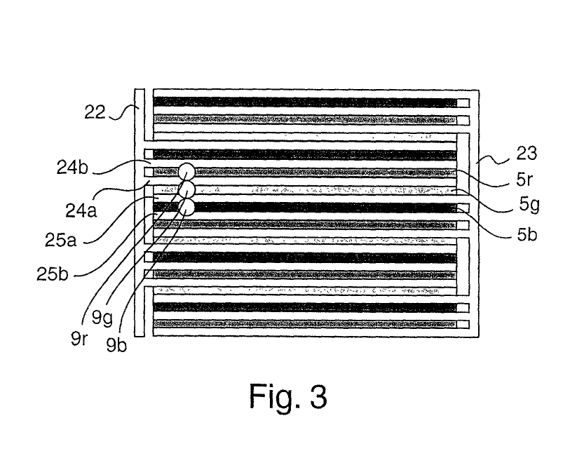

FIG. 3 shows the arrangement of the detecting means according to a first embodiment of the invention.

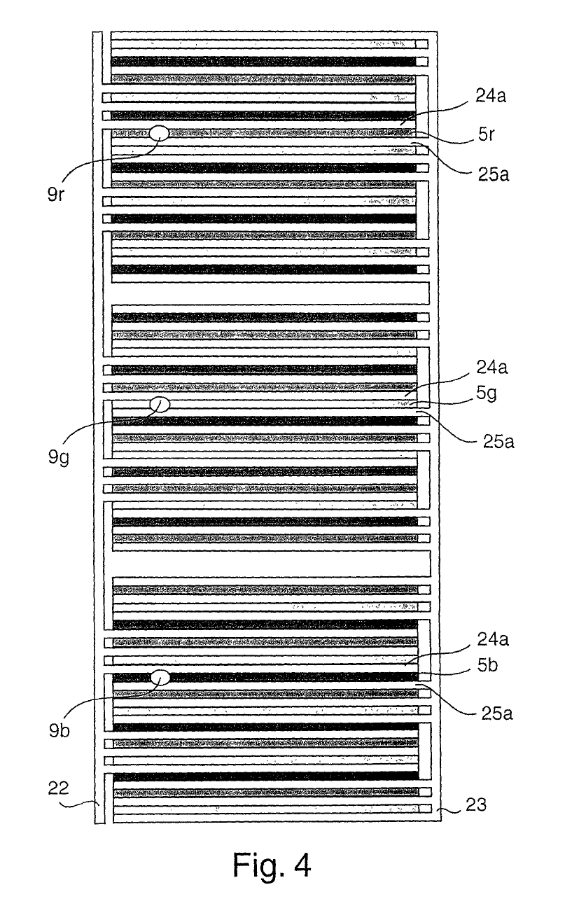

FIG. 4 shows a combination of several configurations according to FIG. 3.

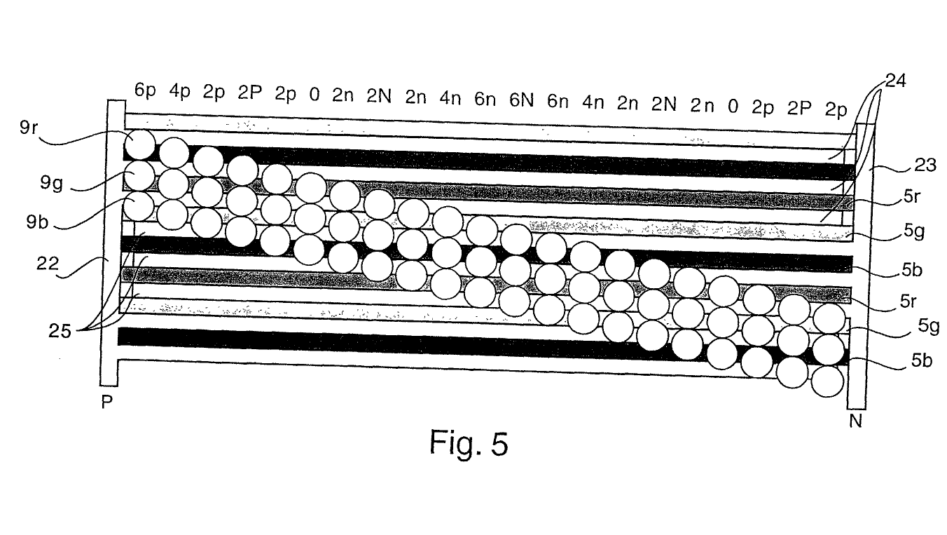

FIG. 5 illustrates the error signal resulting from different beam positions for the configuration in FIGS. 3 and 4.

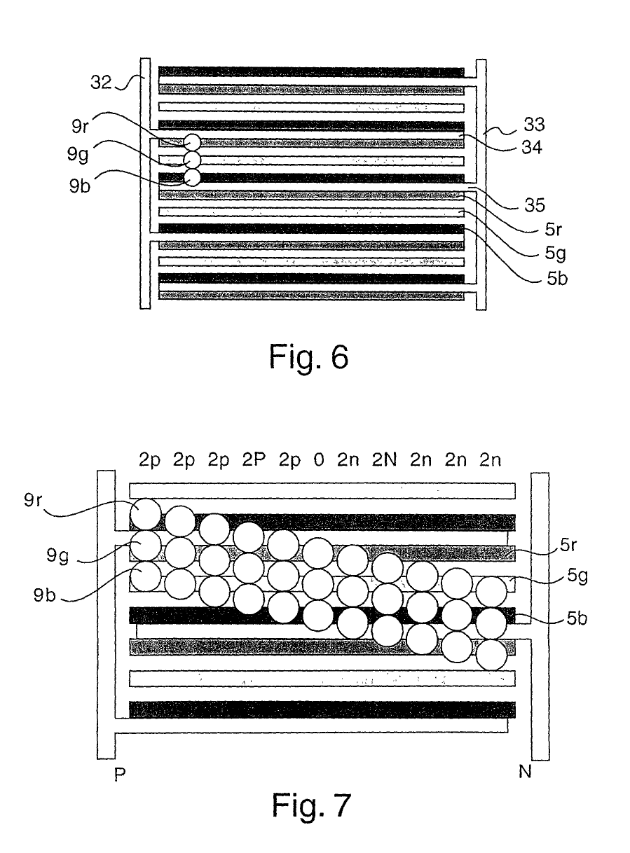

FIG. 6 shows the arrangement detecting means according to a second embodiment of the invention.

FIG. 7 illustrates the error signal resulting from different beam positions for the configuration in FIG. 6.

The tracking picture tube 1 in FIG. 1 comprises a screen portion 2, provided on its inside with a phosphor layer, and a neck portion 3 accommodating three electron guns 4 (only schematically shown in the drawing). The phosphor layer is constituted by three sets of interspersed horizontal strips 5, adapted to emit the colors red 5r, green 5g and blue 5b, respectively, when hit by an electron beam 9r, 9g, 9b from one of the guns 4. The strips are arranged in a regular alternating order, so that two strips representing the same color are always separated by two strips representing the other two colors. In the following description, a three-gun tube will be assumed, although it should be noted that the present invention is not limited to this particular number of electron beams.

A deflection unit 10 is arranged between the electron guns 4 and the screen for deflecting the beams 9 to the correct position 7 on the correct phosphor strip 5. The beam 9 from a particular gun 4 is normally always deflected onto the same set of phosphor strips, i.e. in this particular case there is a “red” gun, a “green” gun and a “blue” gun.

Of course, a different number of guns might be used in the tube, and any different combination of colors. For example, two green and one blue gun may be used.

The screen 2 is also provided with two comb-shaped tracking detecting means 12, 13. In the case of optical tracking, light-emitting strips similar to the strips 5 may be used as detecting means, and the light emitted from these strips is then collected by e.g. photodiodes. Note that two separate tracking phosphors are needed and that the photodiodes should be filtered for the corresponding phosphors in order to achieve a usable tracking signal.

In the following description, electrical tracking is assumed, and the detecting means are in the form of conducting electrodes 12, 13, but this should not be construed as limiting the protective scope.

Each electrode has a number of finger portions 14, 15 which are arranged in an interdigitated fashion. The electrodes 12, 13 can be formed on the screen 2 using e.g. lithography. It is possible, and in some cases preferred, to use only one pair of electrodes 12, 13, covering the entire screen, but it may also be advantageous to have more than two electrodes, forming several pairs of interdigitated comb structures on the screen 2.

The principle of the tracking tube is to use a comparator 17 to detect a signal difference from the electrodes 12, 13 and feedback an output signal 18 to a control unit 19 controlling the deflection unit 10.

According to the prior art (FIG. 2), the finger portions 14, 15 extend between the phosphor strips 5 so that each strip along the length of the electrodes borders one finger portion from each electrode 12, 13, one along the upper side and one along the lower side. This is called “differential configuration”. An electron beam 9r, 9g, 9b hitting the center of a phosphor strip 5r, 5g, 5b will transfer an equal electric charge to the finger portions 14, 15 on each side of this strip. Any deviation from the center will, however, result in a larger electric charge transferred to one of the electrodes 12, 13, thereby creating a potential and/or a current that can be measured by the comparator 17. Such a potential or current thus relates to the vertical position of a beam with respect to the corresponding phosphor strip.

Note that when three beams hit adjacent phosphor strips, the error signal of the center beam will be opposite in sign as compared to side beam error signals.

According to a first embodiment of the present invention, illustrated in FIG. 3, the finger portions 24, 25 of the electrodes 22, 23 are arranged in groups of three, the groups alternately belonging to the two electrodes 22, 23. The central electron beam 9g is deflected onto a green strip 5g located between finger portions 24a, 25a belonging to different electrodes. As a consequence, the two side beams 9r, 9b are deflected onto red and blue strips 5r, 5b adjacent to the green strip 5g, located between finger portions 24a, 24b and 25a, 25b, belonging to the same electrode, respectively.

FIG. 5 illustrates the signal generated by the electrodes for different positions of the three beams 9r, 9g, 9b (symbolized by spots in the Figure). It is assumed that the electrode 22 gives a positive contribution (p, P) while the electrode 23 gives a negative (n, N) contribution. Furthermore, capital letters (P, N) indicate an overlap of the spot and electrode having a larger area than when lower case (p, n) is used, and thus P>p, |N|>|n|.

During the detection of the tracking errors of the green electron beam 9g, the signal for the red and blue beams can be set to zero in order to make sure that the signals from these beams cancel each other. After starting up, the signals of the red and blue beams can be considered to be set equal at the moment of detection in order to minimize the color errors. The same procedure is performed during the data collection of the red and blue beams in order to measure these beam positions with respect to the green phosphor strips.

Optionally, the phosphor strips are arranged differently on different parts of the face plate of the tube, as is illustrated in FIG. 4. In this configuration, no additional shifts in the detected green tracking positions by, for instance, the red beam have to be added in order to determine the position with respect to the read phosphor strip.

It is clear from FIG. 5 that the resulting signal from the three beams is zero only when the beams are centered around the green phosphor strip 5g. A signal which is not equal to zero indicates to the control system that the beams should be moved. This situation is easily understood, as the contributions from the side beams 9r, 9b have exactly the same relationship with finger portions belonging to different electrodes. Therefore, signals from these beams cancel each other, at least near the centered position, as long as the currents are equal in magnitude. The error signal in these positions corresponds to the signal from one beam in differential configuration electrodes. In extremely erroneous positions (to the center and right in FIG. 5), all of the three beams will hit finger portions belonging to the same electrode, resulting in a very strong error signal.

Note that, just like the prior art, the sign of the error signal in relation to the position error alternates, but now only with every group of three strips. The reason is that the finger portion groups alternatingly belong to different electrodes. In other words, in consecutive sweeps of the screen with three beams, a positive error signal will indicate a position error in one direction during the first sweep, and in the opposite direction during the second sweep.

According to a second embodiment of the invention, illustrated in FIG. 6, the number of finger portions is reduced to a third. The finger portions 34, 35 present in FIG. 5 correspond to the center finger portions 24b, 25b in each finger portion group in FIG. 3. In other words, each group of adjacent red, green and blue phosphor strips 5r, 5g, 5b is outlined by two finger portions 34, 35 belonging to different electrodes 32, 33.

The signal generated from the electrodes for different positions of the three beams 9r, 9g, 9b for the configuration in FIG. 6 is illustrated in FIG. 7. Also in this case, a zero signal is only obtained when the three beams are centered around the green phosphor strip 5g. This is not surprising, as the removed finger portions relevant in this position belonged to opposite electrodes, and thus had a zero contribution.

The signals for the red and blue beams are set equal (optionally set equal to zero), in order to minimize the green color error and to make sure that the signals from these beams cancel each other at the moment the data for the tracking error of the green beam is collected.

The same procedure is performed for the data collection of the red and blue beams, in order to measure these positions with respect to the green phosphor strips.

However, the amplitude of the signal is smaller when the position error is large, as in this case, the removed finger portions had a contributing effect on the error signal. The two extreme right positions in FIG. 7 both have a signal which is equal to 2 p, compared to the corresponding signals in FIG. 5 which are 6 p and 4 p. The configuration in FIG. 6 can thus be expected to be most useful when position errors are expected to be small.

It should be understood that the above description of a preferred embodiment does not exclude modifications by the skilled person within the protective scope defined by the claims. For example, the control system may be designed in a different way, depending on the application and desired result. Also, many components in the picture tube, such as the electron guns and the deflection unit have not been described in any detail, as the skilled person is expected to have sufficient knowledge of this technical field.

1. A picture tube (1) comprising
a screen (2) with a plurality of interspersed sets of parallel strips (5r, 5g, 5b) of light-emitting material,
at least one electron gun (4) for generating at least one electron beam (9r, 9g, 9b),
a deflection unit (10) for deflecting said electron beams onto a group of at least three adjacent strips,
at least one pair of comb-shaped electron-detecting means (22, 23; 32, 33) with a plurality of interdigitated finger portions (24, 25; 34, 35) extending parallel with the strips, for generating an electric signal relative to the position of said electron beams,
characterized in that a first peripheral strip (5r) of said group of adjacent strips borders only finger portions (24a, 24b; 34) of the first detecting means (22; 32) in said pair of detecting means, and a second peripheral strip (5b) of said group of adjacent strips borders only finger portions (25a, 25b; 35) of the second detecting means (23; 33) in said pair of detecting means.

2. A picture tube as claimed in claim 1, wherein each peripheral strip (5r, 5b) only borders one finger portion (34, 35) of each detecting means (32, 33).

3. A picture tube as claimed in claim 2, wherein the finger portions (34, 35) are located on the peripheral side of said peripheral strips (5r, 5b).

4. A picture tube as claimed in claim 1, wherein the first peripheral strip (5r) is located between finger portions (24a, 24b) belonging to said first detecting means (22), and the second peripheral strip (5b) is located between finger portions (25a, 25b) belonging to said second detecting means (23).

5. A picture tube as claimed in claim 3, wherein a third of said adjacent strips (5g), centrally located between the peripheral strips (5r, 5b), borders finger portions (24a, 25a) belonging to different detecting means.

6. A picture tube as claimed in any one of the preceding claims, wherein the detecting means (22, 23; 32, 33) are conductive electrodes.

7. A picture tube as claimed in any one of the preceding claims, wherein the detecting means comprise light-emitting material.
